(19) United States
(12) Patent Application Publication
(10) Pub. No.: US 2017/0307311 A1
(43) Pub. Date: Oct. 26, 2017

(54) Simple Heat Exchanger Using Super Alloy Materials for Challenging Applications

(71) Applicant: UNITED TECHNOLOGIES CORPORATION, Farmington, CT (US)

(72) Inventors: Frederick M. Schwarz, Glastonbury, CT (US); Paul W. Duesler, Manchester, CT (US)

(21) Appl. No.: 15/138,491

(22) Filed: Apr. 26, 2016

(51) Int. Cl. F28F 21/08; F28F 1/28; F02C 9/18; F02C 3/04; F28F 1/40; F02C 7/18; F28D 1/047

(52) U.S. Cl. CPC F28F 21/087; F02C 7/185; F28F 1/28; F28D 1/0475; F02C 3/04; F28F 1/40; F02C 9/18; F05D 2220/32; F05D 2260/213

(57) ABSTRACT

A heat exchanger system for use in a gas turbine engine has a plurality of circumferentially spaced heat exchangers. The spaced heat exchangers are formed of a nickel alloy material including more than 50-percent by volume gamma-prime intermetallic phase material. A gas turbine engine is also disclosed.

### BACKGROUND OF THE INVENTION

This application relates to a heat exchanger for providing cooling air in a gas turbine engine.

Gas turbine engines are known and typically include a fan delivering air into a bypass duct as propulsion air, and further providing air into a core housing. Air in the core housing passes into a compressor where it is compressed, and then into a combustor where it is mixed with fuel and ignited. Products of this combustion pass downstream over turbine rotors, driving them to rotate.

As is known, turbine components see very high temperatures and thus cooling air has been typically provided to those components. Historically, the fan and a low pressure compressor have rotated as a single unit along with a fan drive turbine. However, more recently, a gear reduction has been placed between the fan rotor and the fan drive turbine. This allows the fan rotor to rotate at slower speeds and the fan drive turbine to rotate at faster speeds. This raises the challenges on the turbine components and requires more efficient provision of the cooling air.

At the same time, the overall pressure ratio provided by the compressor has increased. Historically, the air to cool the turbine components has been tapped from a location downstream of a highest pressure location on the compressor. However, with the increase in overall pressure ratio, this air has become hotter.

The heat exchangers for cooling this air are thus subject to extreme challenges.

### SUMMARY OF THE INVENTION

In a featured embodiment, a heat exchanger system for use in a gas turbine engine has a plurality of circumferentially spaced heat exchangers. The spaced heat exchangers are formed of a nickel alloy material including more than 50-percent by volume gamma-prime intermetallic phase material.

In another embodiment according to the previous embodiment, the heat exchangers are formed of elongated members having fins on an outer surface.

In another embodiment according to any of the previous embodiments, the elongated members are tubes.

In another embodiment according to any of the previous embodiments, the elongated members extend radially outwardly to an elbow which takes air radially outwardly to the elbow and a second elongated member returns air radially inwardly into a housing for the engine.

In another embodiment according to any of the previous embodiments, there are a plurality of axially spaced heat exchangers.

In another featured embodiment, a gas turbine engine has a compressor section, a combustor section, and a turbine section. A core housing contains the compressor section, the combustor and the turbine section. A first conduit taps hot compressed air to be cooled and passes the air to a heat exchanger. The air is cooled in the heat exchanger and returned to a return conduit. The return conduit passes the cooled air to the turbine section. The heat exchanger includes a plurality of circumferentially spaced heat exchangers. The circumferentially spaced heat exchangers are formed of a nickel alloy material including more than 50-percent by volume gamma-prime intermetallic phase material.

In another embodiment according to the previous embodiment, the heat exchangers are formed of elongated members having fins on an outer surface.

In another embodiment according to any of the previous embodiments, the elongated members are tubes.

In another embodiment according to any of the previous embodiments, the elongated members extend radially outwardly to an elbow which takes air radially outwardly to the elbow and a second elongated member returns air radially inwardly into a housing for the engine.

In another embodiment according to any of the previous embodiments, there are a plurality of axially spaced heat exchangers.

In another embodiment according to any of the previous embodiments, the heat exchanger is positioned in a bypass duct outwardly of the core housing.

In another embodiment according to any of the previous embodiments, the heat exchanger is positioned forwardly of a pivot point for a pivoting portion of the core housing, and the exchanger being positioned radially outwardly of a fixed inner structure.

In another embodiment according to any of the previous embodiments, the heat exchanger is positioned within the core housing.

In another embodiment according to any of the previous embodiments, a pivoting door selectively allows bypass air to pass over the heat exchanger for cooling the heat exchanger.

In another embodiment according to any of the previous embodiments, a valve selectively controls the flow of the compressed air to the heat exchanger.

In another embodiment according to any of the previous embodiments, a valve selectively controls the flow of the compressed air to the heat exchanger.

In another embodiment according to any of the previous embodiments, a duct for controlling the flow of air downstream of the heat exchanger is positioned upstream of a fan nozzle plane of the gas turbine engine.

In another embodiment according to any of the previous embodiments, a ramp causes a lower pressure downstream of the ramp to facilitate flow of the bypass air over the heat exchanger and into an exhaust.

In another embodiment according to any of the previous embodiments, a duct for controlling the flow of air downstream of the heat exchanger is positioned downstream of a nozzle plane.

In another embodiment according to any of the previous embodiments, the return conduit passing into a strut and radially inwardly to pass to the turbine section.

These and other features may be best understood from the following drawings and specification.

### BRIEF DESCRIPTION OF THE DRAWINGS

FIG. 1 schematically shows a gas turbine engine.

FIG. 2 schematically shows the provision of a turbine cooling system.

FIG. 3A shows a first embodiment heat exchanger.

FIG. 3B shows an alternative embodiment.

FIG. 3C shows a further detail of the embodiment of FIG. 3B.

FIG. 4A shows an alternative location for a heat exchanger embodiment.

FIG. 4B shows yet another alternative for a heat exchanger embodiment.

### DETAILED DESCRIPTION

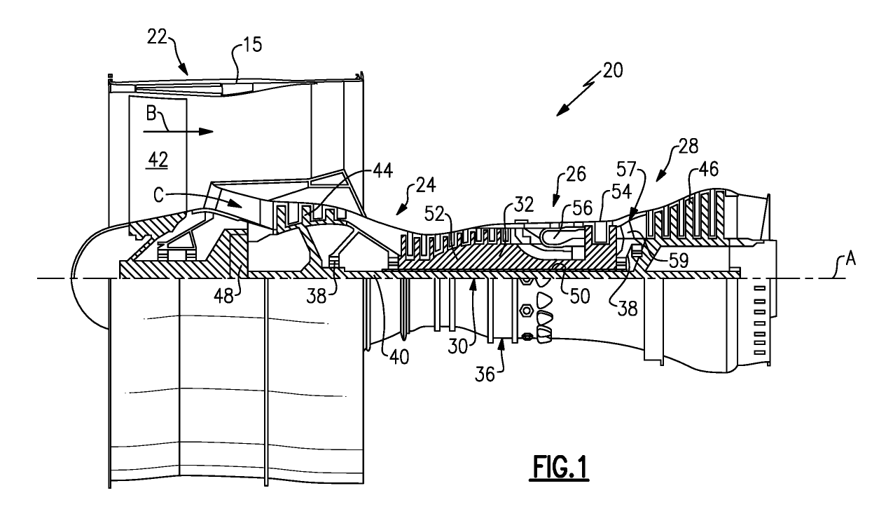

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7°R)]^{0.5}. The “Low corrected fan tip speed” as disclosed herein according to one non-limiting embodiment is less than about 1150 ft/second (350.5 meters/second).

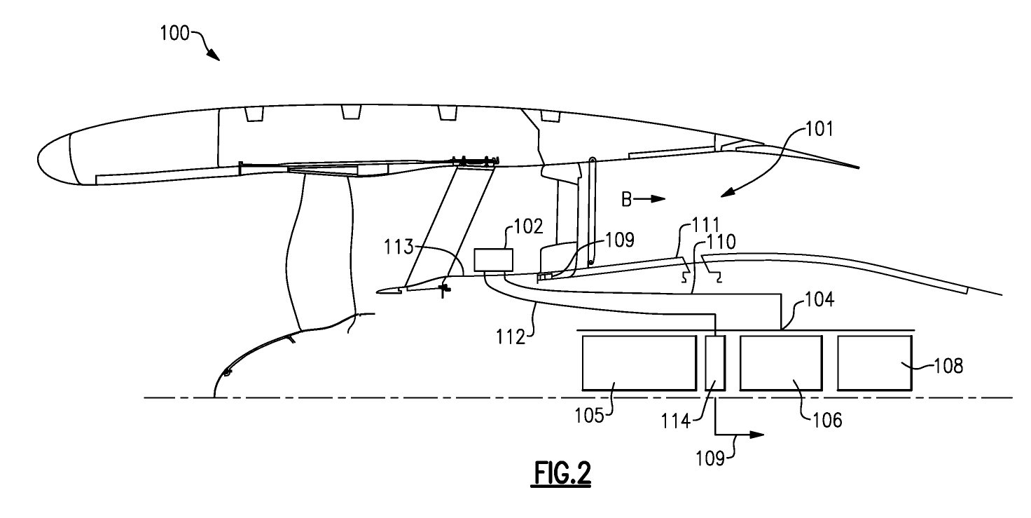

FIG. 2 shows an engine 100 with turbine cooling system 101. Heat exchanger 102 is placed in the bypass duct B. Air from a location 104, which is downstream of a high pressure compressor 105, is tapped. The air is shown tapped outwardly of a combustor 106, however, other locations may be utilized. The air is cooled and then provided to the turbine section 108 for cooling components in the turbine section 108. The tapped air is tapped through conduit 110 to the heat exchanger 102. As shown, the heat exchanger 102 is positioned forwardly of a pivoting housing member 111 having a pivot point 109. Stated another way, the heat exchanger 102 is placed in the bypass duct B, but outwardly of a fixed inner structure 113. This simplifies the connection of the conduits 110 and 112 to the heat exchanger 102. Conduit 112 returns the air back into the housing and through a hollow strut 114, where it passes radially inwardly and then to the turbine section 108 at 109.

Preferably there are a plurality of circumferentially spaced conduits 110, 112 and struts 114.

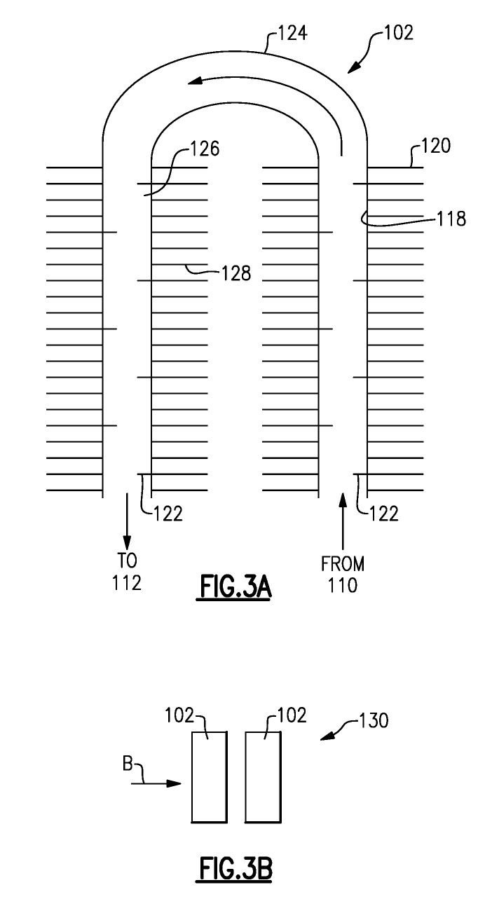

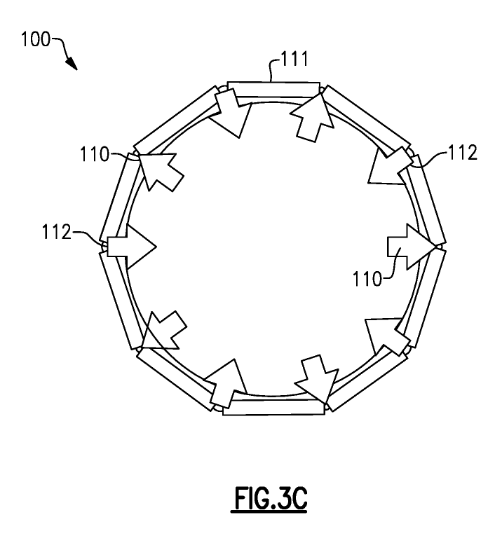

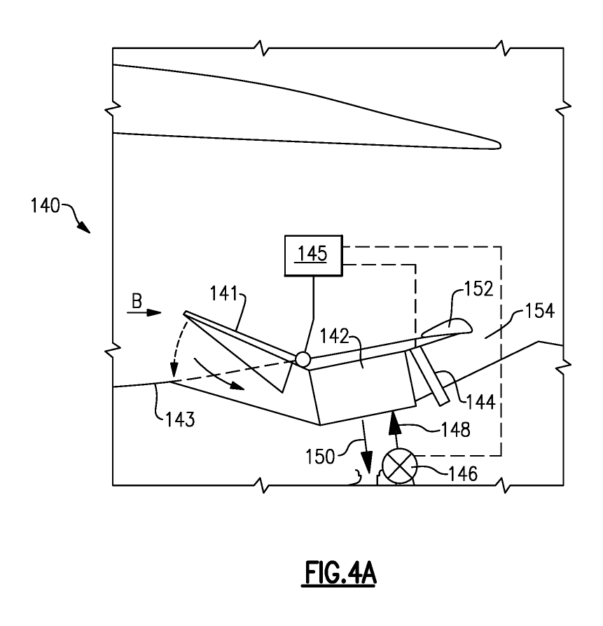

FIG. 3A shows an embodiment of the heat exchanger 102. Air from conduit 110 passes into a tube 118. The tube 118 is provided with fins 120. Further, trip strips or other turbulence causing structures 122 may be formed on an inner wall of the tube 118. The tube 118 is preferably relatively short, as radially outer locations will provide less efficient cooling than radially inner locations.

The air reaches an elbow 124 and then returns inwardly through another tube 126 which may be provided with fins 128 and also trip strips, if desired. That air returns to the conduit 112.

As shown in FIG. 3B, there may be axially spaced heat exchangers 102, spaced serially into the engine in an embodiment 130.

FIG. 3C shows a feature of the engine 100 wherein there are a plurality of circumferentially spaced conduits 110 and conduits 112, shown schematically. This eliminates dead zones which will decrease the efficiency of cooling.

In embodiments, the heat exchanger tubes 118 and 126, and optionally the fins 120 and 128 and trip strips 122 may be formed of a super alloyed material typically utilized for turbine components. In particular, a cast nickel alloy material including more than 50-percent by volume gamma-prime (Y′). Intermetallic phase material may be utilized as the Y′ material. The intermetallic phase material may be Ni3AL or Ni3TI as examples.

The use of this alloy, which has been typically reserved for use in the turbine, allows the heat exchanger to survive much higher temperatures than with typical heat exchangers utilized in gas turbine engines. As such, the challenges mentioned above can be addressed.

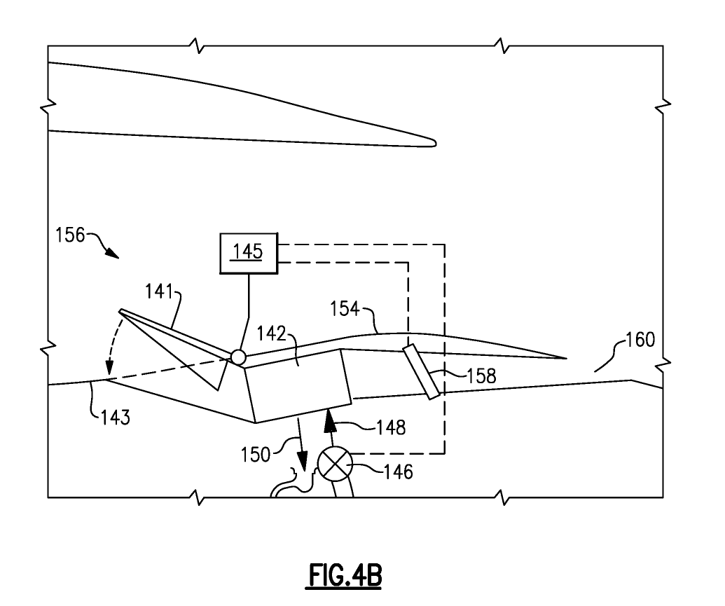

FIG. 4A shows an alternative embodiment 140 and a heat exchanger 142 is positioned within a core housing 143. A pivoting door 141, which is controlled by a control 145, such as the overall engine control (FADEC) or may be a standalone control. Door 141 is pivoted to the illustrated open position when cooling is desired and pivoted to a closed position when cooling is no longer necessary, such as at cruise or idle conditions.

Cooling air passes over the heat exchanger 142 and through a duct 144, which may also be selectively closed by control 145. Air is tapped through a valve 146 from the hot location, as in the FIG. 2 embodiment, and into a conduit 148 for delivery into the heat exchanger 142, and then back through a conduit 150 to be delivered to the turbine section. In this embodiment, the duct 144 is positioned upstream of a fan nozzle plane 154. This allows a lower downstream pressure, and even fan flow separation. A ramp 152 may be placed at the location forward of the exhaust to also facilitate these goals.

FIG. 4B shows an alternative embodiment 146, which is similar to the FIG. 4A embodiment, except that the duct 158 is positioned downstream of the nozzle plane 154, as is the exhaust 160.

The FIGS. 4A and 4B location can receive heat exchangers, such as those disclosed in FIGS. 3A-3C.

Although embodiments of this invention have been disclosed, a worker of ordinary skill in this art would recognize that certain modifications would come within the scope of this invention. For that reason, the following claims should be studied to determine the true scope and content of this invention.

1. A heat exchanger system for use in a gas turbine engine comprising:
a plurality of circumferentially spaced heat exchangers, said spaced heat exchangers being formed of a nickel alloy material including more than 50-percent by volume gamma-prime intermetallic phase material.

2. The heat exchanger system as set forth in claim 1, wherein said heat exchangers are formed of elongated members having fins on an outer surface.

3. The heat exchanger system as set forth in claim 2, wherein said elongated members are tubes.

4. The heat exchanger system as set forth in claim 2, wherein said elongated members extend radially outwardly to an elbow which takes air radially outwardly to said elbow and a second elongated member returns air radially inwardly into a housing for said engine.

5. The heat exchanger system as set forth in claim 1, wherein there are a plurality of axially spaced heat exchangers.

6. A gas turbine engine comprising:
a compressor section, a combustor section, a turbine section;
a core housing containing said compressor section, said combustor and said turbine section;
a first conduit for tapping hot compressed air to be cooled and passing said air to a heat exchanger, said air being cooled in said heat exchanger and returned to a return conduit, said return conduit passing the cooled air to said turbine section; and
said heat exchanger including a plurality of circumferentially spaced heat exchangers, and said circumferentially spaced heat exchangers being formed of a nickel alloy material including more than 50-percent by volume gamma-prime intermetallic phase material.

7. The gas turbine engine as set forth in claim 6, wherein said heat exchangers are formed of elongated members having fins on an outer surface.

8. The gas turbine engine as set forth in claim 7, wherein said elongated members are tubes.

9. The gas turbine engine as set forth in claim 7, wherein said elongated members extend radially outwardly to an elbow which takes air radially outwardly to said elbow and a second elongated member returns air radially inwardly into a housing for said engine.

10. The gas turbine engine as set forth in claim 7, wherein there are a plurality of axially spaced heat exchangers.

11. The gas turbine engine as set forth in claim 6, wherein said heat exchanger is positioned in a bypass duct outwardly of said core housing.

12. The gas turbine engine as set forth in claim 11, wherein said heat exchanger is positioned forwardly of a pivot point for a pivoting portion of said core housing, and said exchanger being positioned radially outwardly of a fixed inner structure.

13. The gas turbine engine as set forth in claim 6, wherein said heat exchanger is positioned within said core housing.

14. The gas turbine engine as set forth in claim 13, wherein a pivoting door selectively allows bypass air to pass over said heat exchanger for cooling said heat exchanger.

15. The gas turbine engine as set forth in claim 14, wherein a valve selectively controls the flow of said compressed air to said heat exchanger.

16. The gas turbine engine as set forth in claim 13, wherein a valve selectively controls the flow of said compressed air to said heat exchanger.

17. The gas turbine engine as set forth in claim 13, wherein a duct for controlling the flow of air downstream of said heat exchanger is positioned upstream of a fan nozzle plane of said gas turbine engine.

18. The gas turbine engine as set forth in claim 17, wherein a ramp causes a lower pressure downstream of said ramp to facilitate flow of the bypass air over said heat exchanger and into an exhaust.

19. The gas turbine engine as set forth in claim 13, wherein a duct for controlling the flow of air downstream of said heat exchanger is positioned downstream of a nozzle plane.

20. The gas turbine engine as set forth in claim 6, wherein said return conduit passing into a strut and radially inwardly to pass to the turbine section.
